(19) United States
(12) Patent Application Publication
(10) Pub. No.: US 2018/0211169 A1
(43) Pub. Date: Jul. 26, 2018

(54) SYSTEM AND METHOD FOR PREDICTING FUTURE TRENDING TOPICS

(71) Applicant: VISWANATHA SASTRY RACHAKONDA, Jersey City, NJ (US)

(72) Inventor: VISWANATHA SASTRY RACHAKONDA, Jersey City, NJ (US)

(21) Appl. No.: 13/677,737

(22) Filed: Nov. 15, 2012

(51) Int. Cl. G06N 5/04

(52) U.S. Cl. CPC G06N 5/04; G06F 17/30864

(57) ABSTRACT

A computer implemented method for computing a set of future trending topics is provided. The method includes (i) obtaining one or more trended topics associated with past occurrences, (ii) processing a first input that includes a selection of present information that is not currently trending, (iii) computing the set of future trending topics and occurrences of the set of future trending topics based on (a) the present information, and (b) at least one past occurrence of at least one trended topic that is associated with the present information. The present information is associated with an occurrence of at least one future event.

### BACKGROUND

### Technical Field

The embodiments herein generally relate to predicting future trending topics, and more particularly, predicting of future trending topics based on present information and one or more trended topics in the past.

### Description of the Related Art

Online content is a huge market for content providers for advertising. Users may use free content that are made available in web pages by various content providers, or subscribe to topics that are related to their interest. However, challenge emerges when a content provider publishes content on a topic that is relevant to only few users. For example, an article on treating a new disease through an innovative vaccine may not be interesting to a user with technical skills in software. Hence, the likelihood of a large number of users benefitting from such content is minimum. This adversely impacts revenue generation potential of the content provider.

One approach for making content relevant to more number of users is by determining future content needs. Currently, content publishers have to manually predict future trending topics, likely to be searched by users, based on their personal judgment and experience. Such predictions have no quantifiable objective basis in as much as they are not derived from any mathematically rigorous methodology. There are certain tools that predict future search topics. However such tools do not assist the content provider to increase a number of visits to their websites. Thus, there remains a need for a tool that assists content providers by predicting future topics and, therefore, maximizes the number of visits to their websites driven by searches on such future topics.

### SUMMARY

In view of the foregoing, the embodiment herein provides a computer implemented methodology for forecasting future trending topics. The method includes (i) obtaining one or more trending topics associated with past occurrences, (ii) processing a selection of present information that is not currently trending, (iii) computing the set of future trending topics and occurrences of the set of future trending topics based on (a) the present information, and (b) at least one past occurrence of at least one trended topic that is associated with the present information. The present information is associated with occurrence of at least one future event.

For each future trending topic within the set of future trending topics, one or more related keywords may be provided. Content on each trending topic may be generated based on at least one or more related keywords. The number of days a future trending topic within the set of future trending topics is likely to persist may be computed based on the number of days at least one topic that relates to this future trending topic trended in the pastA weight that indicates the odds of trending for each future topic from the set of future trending topics may be assigned for each future trending topic based on the number of occurrences of past events relating to each of these topics.

In another embodiment, a system for computing a set of future trending topics is provided. The system includes (i) a memory unit that stores a set of modules, (ii) a display unit that displays the set of future trending topics and occurrences of the set of future trending topics, and (iii) a processor that executes the set of modules. The set of Modules include (a) a topic collection module that is configured to perform a selection of one or more trending topics associated with past occurrences, (b) an information collection module that is configured to perform a selection of present information that is not currently trending, and (c) a future topics computing module that is configured to compute the set of future trending topics and occurrences of the set of future trending topics based on (i) the present information and (ii) at least one past occurrence of at least one trended topic that is associated with the present information.

The set of modules further includes a keyword generation module that may be configured to generate one or more related keywords for each future trending topic from the set of future trending topics. Content on each future trending topic may be generated based on at least one or more related keywords. A persistence computing module for the set of modules may be configured to compute the number of days a future trending topic from the set of future trending topics is likely to trend based on the number of days at least one topic that relates to the future trending topic trended in the past. A weight assigning module for the set of modules may be configured to assign a weight to each future trending topic and indicates the odds of trending for each future trending topic within the set of future trending topics based on the number of occurrences of past events relating to each future trending topic.

In yet another embodiment, a methodology for generating an updated set of future trending topics is provided. The method includes, (i) obtaining one or more trended topics associated with past occurrences, (ii) performing a selection of present information that is not currently trending, but are associated with occurrence of at least one event in the future. (iii) computing the set of future trending topics and occurrences of the set of future trending topics based on: (a) the present information, and (b) at least one past occurrence of at least one trended topic associated with the present information, (iv) processing a selection of present information that are associated with an occurrence of a future event. (v) computing odds of trending for a topic that relates to a future event based on at least one past occurrence of trended topic(s) associated with the present information, and (vi) updating the set of future trending topics on occurrence of the future event associated with the topic to obtain the updated set of future trending topics.

The number of days the topic of the future event is likely to trend may be computed based on the number of days at least one trending topic that relates to the topic trended in past. A weight that indicates the odds of trending for the future event may be assigned based on the number of occurrences of past events relating to that topic.

These and other aspects of the embodiments herein can be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a user system and a future topics determining tool for determining a set of future trending topics according to an embodiment herein;

FIG. 2 illustrates an exploded view of the future topics determining tool of FIG. 1 according to an embodiment herein;

FIG. 3 illustrates a user interface view of an internet portal of a topic provider from which one or more topics are collected over a period time and stored in the database of FIG. 2 as one or more trended topics according to an embodiment herein;

FIG. 4 illustrates a user interface view of a portal of a topic provider with present trending topics that are stored in the database of FIG. 2 and used for computing a set of future trending topics according to an embodiment herein;

FIG. 5 is a flow diagram illustrating a method of predicting a set of future trending topics and occurrences of the set of future trending topics based on one or more trended topics according to an embodiment herein;

FIG. 6 illustrates a table view of trended topics and occurrences of trended topics over a period of year 2008 to 2011 for the month of September obtained from the database of FIG. 2 according to an embodiment herein;

FIG. 7 illustrates a table view of a set of future trending topics for the month of September and occurrence of each future trending topic of the set of future trending topics computed based on an occurrence of the trending topics of FIG. 6 according to an embodiment herein;

FIG. 8 is a flow diagram illustrating a method of predicting a set of future trending topics and occurrences of the set of future trending topics based on one or more trending topics associated with past occurrences and one or more present trending topics according to an embodiment herein;

FIG. 9 illustrates a table view of a set of future trending topics predicted based on one or more trended topics and one or more present trending topics according to an embodiment herein;

FIG. 10 is a flow diagram illustrating a method of predicting a set of future trending topics and occurrences of the set of future trending topics based on present information about future events and one or more trended topics according to an embodiment herein;

FIG. 11 illustrates an exemplary view of present information about an occurrence of future events and is not currently trending according to an embodiment herein;

FIG. 12 illustrates a table view of a first set of future trending topics and a second set of future trending topics that are predicted based on the present information of

FIG. 11 and at least one past occurrences of at least one trended topic that is associated with the present information according to an embodiment herein;

FIG. 13 is a flow diagram illustrating a method of generating an updated set of future trending topics by generating a set of future trending topics and updating the set of future trending topics with a topic that relates to a future event according to an embodiment herein;

FIG. 14 illustrates an exemplary view of the present information of FIG. 11 with additional present information that differs from the present information according to an embodiment herein;

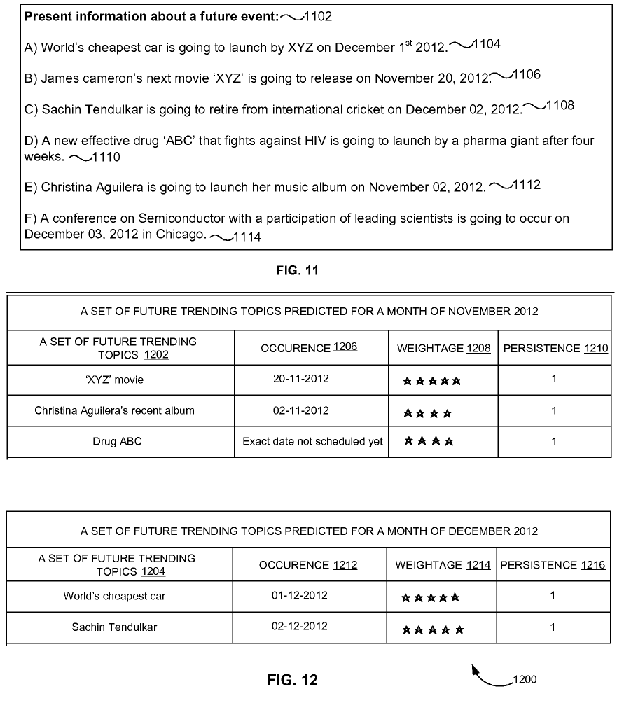

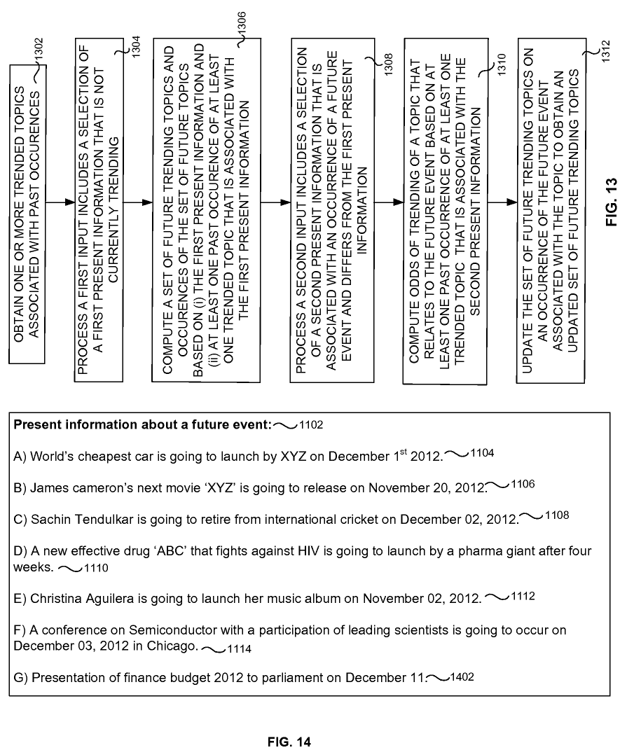

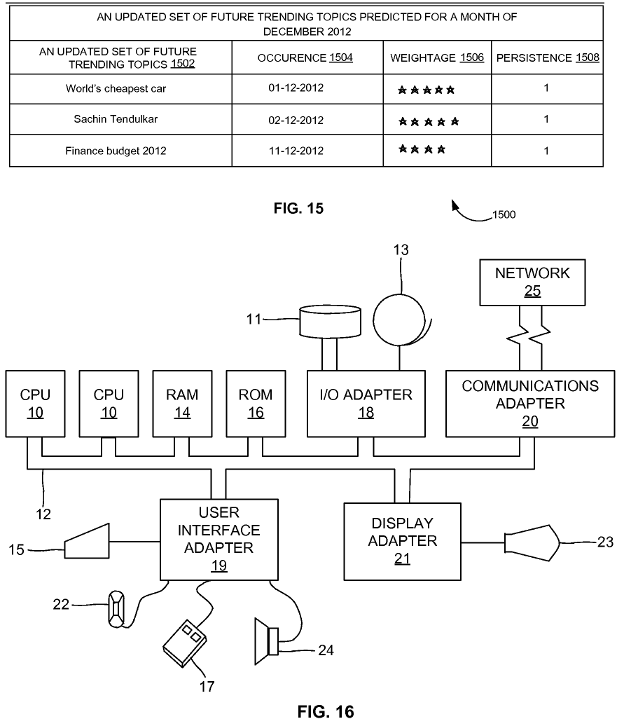

FIG. 15 illustrates a table view of an updated set of future trending topics obtained by updating the set of future trending topics of FIG. 12 with a topic that corresponds to the additional present information of FIG. 14 according to an embodiment herein; and

FIG. 16 illustrating a representative computer architecture for practicing the embodiments herein.

### DETAILED DESCRIPTION OF PREFERRED EMBODIMENTS

The embodiments herein and the various features and advantages thereof are explained in more detail with reference to the non-limiting embodiments that are illustrated in the accompanying drawings and elucidated in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

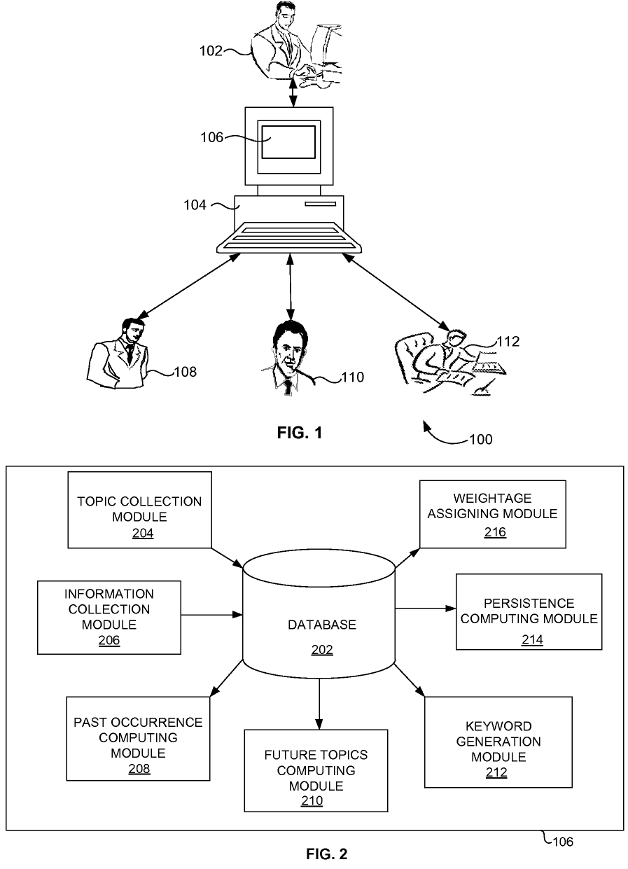

As mentioned, there remains a need for a tool that assists a content provider by predicting future trending topics and maximizes the number of visits to content of such future trending topics. The embodiment herein achieves this by providing a tool that predicts future trending topics based on present information and one or more trended topics in a past. Referring now to the drawings, and more particularly to FIGS. 1 through 16, where similar reference characters denote corresponding features consistently throughout the figures, illustrate the preferred embodiments.

FIG. 1 illustrates a system view 100 of a user 102 communicating with a user system 104 and a future topics determining tool 106 for determining a set of future trending topics according to an embodiment herein. The future topics determining tool 106 determines the set of future trending topics that are relevant to one or more of content consumers 108. In one embodiment, a content provider 110 obtains the set of future trending topics that are predicted by the future topics determining tool 106. The content provider 110 may create an assignment to one or more content writers 112 to create content on the set of future trending topics.

In one embodiment, the future topics determining tool 106 provides the one or more content writers 112, one or more alternative related keywords for each future trending topic of the set of future trending topics. The one or more content writers 112 create content on each future trending topic based on the one or more alternative related keywords. In one embodiment, the content provider 110 and the one or more content writers 112 are same.

FIG. 2 illustrates an exploded view of the future topics determining tool 106 of FIG. 1 according to an embodiment herein. The future topics determining tool 106 includes a database 202, a topic collection module 204, an information collection module 206, a past occurrence computing module 208, a future topics computing module 210, a keyword generation module 212, a persistence computing module 214, and a weight assignment module 216. The database 202 stores one or more topics that trended in past, an occurrence of each trended topic of the one or more trended topics, one or more present trending topics, an occurrence of each present trending topic, and a persistence of each trending topic. The persistence of each trending topic provides a data on the number of days during each trended topic was among the the highly searched topics on the Internet. Hereinafter, throughout the description of various embodiments, the trended topics are defined as topics that were highly searched on the internet in a given time period (e.g., hourly basis, daily basis, weekly basis, monthly basis, or yearly basis). Similarly, the present trending topics are defined as topics that are currently accelerating in number of related searches on the internet.

The topic collection module 204 processes a first input that includes a selection of one or more topics from data provider's portal. For example, such data provider's portal may be a New York Times, web/internet information providing company, Google news, etc. The topics are collected over a period of time with a corresponding time stamp and stored in the database 202 as the one or more trended topics.

The topic collection module 204 processes a second input that includes a selection of one or more present trending topics. Data associated with the present trending topics are collected over a period of time with a time stamp and stored into the database 202. The occurrence computing module 208 computes and retrieves an occurrence of each trended topic and number of occurrences of each trended topic (repetition) over a period of time from the database 202.

The future topics computing module 210 determines a set of future topics that are likely to be relevant to one or more content consumers 108 based on the one or more trended topics, the one or more present trending topics, and/or one or more present information that includes data on occurrence of future events. In one embodiment, a present trending topic of the one or more present trending topics is associated with at least one similar past trended topic that are stored in the database 202. In another embodiment, the present trending topic is not associated with the one or more trended topics.

The keyword generation module 212 generates one or more related keywords for each future trending topic of the set of future trending topics. The one or more related keywords are provided to the content writer 112. The content writer 112 generates a document for each future trending topic based on the one or more related keywords. The persistence computing module 214 computes the number of days a future trending topic from the set of future trending topics is likely to be trending based on the number of days at least one topic that is related to the future trending topic trended in past.

The weight assigning module 216 assigns a weight for each future trending topic from the set of future trending topics based on the number of occurrences of past trended events relating to the each future trending topic. The weight indicates odds of trending for the each future trending topic.

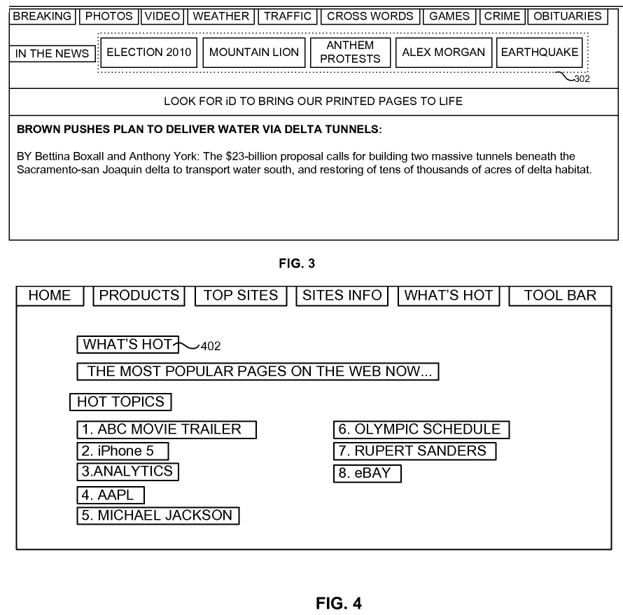

FIG. 3 illustrates a user interface view of an internet portal of a topic provider from which one or more topics 302 are collected over a period time and stored in the database 202 of FIG. 2 as one or more trended topics according to an embodiment herein. The portal of the topic provider includes the one or more topics 302. For example, for a given day the one or more topics 302 include elections 2010, protests against an anthem , Alex Morgan, and Earthquake. The user 102 selects those topics. The topic collection module 204 collects the topics by processing a selection of the one or more topics 302 and store into the database 202. Similarly, topics are collected over a period of time and store into the database 202 as one or more trended topics.

FIG. 4 illustrates the user interface view of a portal of a topic provider with present trending topics that are stored in the database 202 of FIG. 2 and used for computing a set of future trending topics according to an embodiment herein. The portal of the topic provider includes hot topics 402 that are currently trending. For example, the hot topics 402 may include ABC movie trailer, earthquake, iphone® 5, analytics, AAPL, Michael Jackson, Olympic schedule, Rupert sanders, and eBay®. The user 102 selects those present trending topics. The topic collection module 204 collects the present trending topics by processing a selection of the present trending topics and stores in the database 202 of FIG. 2.

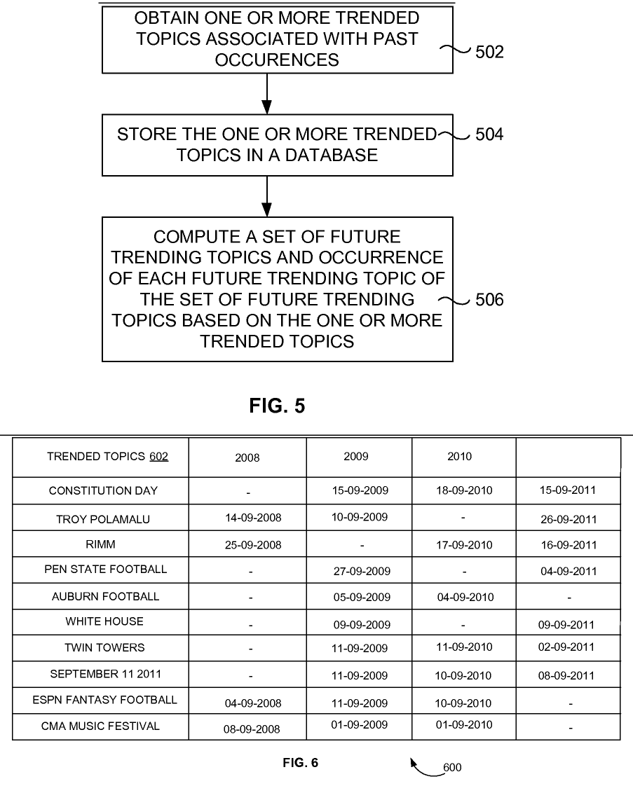

FIG. 5 is a flow diagram illustrating a method of predicting a set of future trending topics and occurrences of the set of future trending topics based on the one or more trended topics according to an embodiment herein. In step 502, one or more trended topics associated with past occurrences are obtained. In one embodiment, the one or more trended topics are obtained by processing the user 102 input includes a selection of one or more highly searched topics on the internet over a period of time by the topic collection module 204. In step 504, the user 102 stores the one or more trended topics into the database 202 with a corresponding time stamp. In step 506, a set of future trending topics and occurrence of each future trending topic within the set of future trending topics are computed (e.g., using the future topics computing module 210 of FIG. 2) based on the one or more trended topics.

FIG. 6 illustrates a table view 600 of trended topics 602 and occurrences of the trended topics 602 over the period 2008 to 2011 for the month of September are obtained from the database 202 of FIG. 2 according to an embodiment herein. For example, a trended topic “constitution day” was in the list of highly searched topics for the month of September for the years 2009, 2010 and 2011. However, the topic “constitution day” was not trending during the year of 2008. The past occurrence computing module 208 processes an input from the user 102 to obtain a list of the trended topics 602 for the month of September over 2008 to 2011 from the database 202. The future topics computing module 210 computes an occurrence of a similar event (searching for ‘constitution day’) for the year of 2012 based on past occurrences of an associated trended topic ‘constitution day’. Similarly, based on past occurrences of each trended topic of the trended topics 602 (e.g., Troy polamalu, Rimm, Pen state football, Auburn football, White house, Twin towers, Sep. 11, 2011, ESPN fantasy football, CMA music festival), a set of future trending topics and an occurrence of a set of future trending topics are computed.

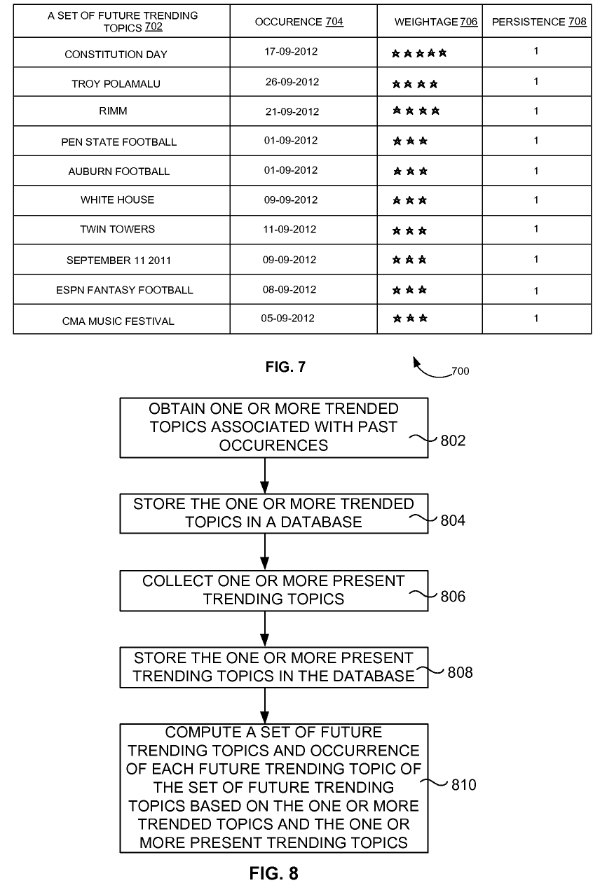

FIG. 7 illustrates a table view 700 of a set of future trending topics 702 for the month of September and occurrence 704 of each future trending topic from the set of future trending topics 702 are computed based on occurrence of the trended topics 602 of FIG. 6 according to an embodiment herein. The weight 706 and persistence 708 are computed for each future trending topic. The weight assigning module 216 assigns a weight for a future trending topic of the set of future trending topics 702 based on number of occurrences of past trended topics that relate to the future trending topic. For example, a future trending topic “constitution day” is assigned with highest weight since the topic “constitution day” was an highly searched topic continuously for three years in row.

The persistence computing module 214 computes a persistence of a future trending topic from the set of future trending topics 702 based on the persistence of a topic that occurred in the past and relates to the future trending topic. For example, the topic “constitution day” trended for a single day in past occurrences, the persistence computing module 214 computes the persistence of future occurrence of the topic “constitution day” as a single day. The above example of predicting the set of future trending topics 702 based on trended topics 602 is shown as computed for the month of September. However, the future topics computing module 210 of the future topics determining tool 106 of FIG. 1 computes a set of future trending topics for years.

FIG. 8 is a flow diagram illustrating a method of predicting a set of future trending topics and occurrences of the set of future trending topics based on one or more trended topics associated with past occurrences and one or more present trending topics according to an embodiment herein. In step 802, one or more trended topics associated with past occurrences are obtained. In one embodiment, the one or more trended topics are obtained by processing a first input of user 102 that includes a selection of one or more highly searched topics on the internet over a period of time by the topic collection module 204. In step 804, the one or more trended topics are stored in the database 202 with a corresponding time stamp. In step 806, the one or more present trending topics are collected. In one embodiment, the one or more present trending topics are collected by processing a second input of the user 102 that includes selecting the one or more present trending topics. In step 808, the one or more present trending topics are stored in the database 202. In step 810, the set of future trending topics and occurrence of each future trending topic from the set of future trending topics are computed based on the one or more trended topics and the one or more present trending topics.

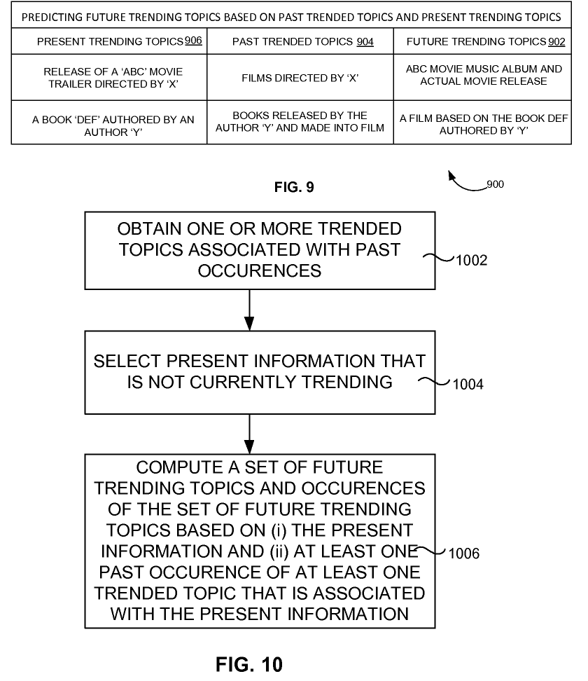

FIG. 9 illustrates a table view 900 of a set of future trending topics 902 predicted based on one or more trended topics 904 and one or more present trending topics 906 according to an embodiment herein. For example, suppose one of the present trending topics of the one or more present trending topics 906 with increasing number of related searches on the internet currently is ‘release of a ABC movie trailer directed by the director X’. Based on past trended topics such as films directed by the director X, and the current trending topic ‘release of a ABC movie trailer directed by the director X’, the future topics computing module 210 predicts odds of occurrence of future topics such as ‘a musical album of the ABC movie’ and ‘release of actual ABC movie’ that are likely to be in highly searching topics.

In another example, a second present trending topic of the one or more present trending topics 906 with increasing number of related searches in internet currently is ‘a book DEF authored by an author Y’. Based on past trended topics such as books released by the author Y and made into film, and the present trending topic ‘a book DEF authored by an author Y’, the future topics computing module 210 predicts odds of occurrence of topics such as ‘A film based on the book DEF authored by Y’ that are likely to be in highly searching topics. In one embodiment, occurrence of event that is associated with each future trending topic is searched in internet. Then, occurring of each future trending topic that is associated with the event is scheduled.

FIG. 10 is a flow diagram illustrating a method of predicting a set of future trending topics and occurrences of the set of future trending topics based on present information about future events and one or more trended topics according to an embodiment herein. In step 1002, one or more trended topics associated with past occurrences are obtained. In one embodiment, the one or more trended topics are obtained by processing a first input of user 102 includes a selection of one or more highly searched topics in the internet over a period of time by the topic collection module 204. In one embodiment, the one or more trended topics is stored in the database 202 a corresponding time stamp. In step 1004, the present information that is not currently trending is selected. In one embodiment, the information collection module 206 of FIG. 2 processes the user 102 input includes a selection of the present information about future events. In one embodiment, the present information includes information about occurrence of more than one future events . In another embodiment, the present information includes information about occurrence of a single future event. In step 1006, the set of future trending topics and occurrence of the set of future trending topics are computed based on the present information and at least one past occurrence of at least one trended topic that is associated with the present information.

FIG. 11 illustrates an exemplary view of present information 1102 about an occurrence of future events currently trending not according to an embodiment herein. In one embodiment, the present information 1102 is an announcement about an occurrence of future events relating to topics. For example, the announcements are about launching of world's cheapest car 1104, releasing of James Cameron's next movie ‘xyz’ 1106, retirement of Sachin Tendulkar from international cricket 1108, a new drug for treating HIV 1110, launching of Christina Aguilera's next music album 1112, and a conference on semiconductor 1114. The information collection module 206 processes an input that includes a selection of the present information 1102. In one embodiment, the present information 1102 is stored in the database 202.

FIG. 12 illustrates a table view 1200 of a first set of future trending topics 1202 and a second set of future trending topics 1204 that are predicted based on the present information 1102 of FIG. 11 and at least one past occurrence of at least one trended topic that is associated with the present information 1102 according to an embodiment herein. For example, the first set of future trending topics 1202 is predicted for the month of November 2012, whereas the second set of future trending topics 1204 is predicted for the month of December 2012. Further, for each future trending topics of the first set of future trending topics 1202, an occurrence 1206, weight 1208 and persistence 1210 are computed. Similarly, for each future trending topics of the second set of future trending topics 1204, an occurrence 1212, weight 1214 and persistence 1216 are computed.

For an instance, when the present information on an occurrence of the conference on semiconductor 1114 does not have any related trended topics. The weight assigning module 216 of FIG. 2 assigns only a lesser weight for searching a topic that relates to the conference on semiconductor 1114.

Similarly, for instance, a present information such as launching of world's cheapest car 1104 have related past occurrences of trended topics such as “an economical car xyz launched in 2011”, and an “ cheapest car of the year 2010”. The weight assigning module 216 assigns a weight for searching a topic that relates to the launching of world's cheapest car 1104 based on a number of occurrences of related trended topics (“an economical car xyz launched in 2011” and “cheapest car of the year 2010”). Similarly, the weight 1208 of each future trending topic of the first set of future trending topics 1202, and the weight 1214 of each future trending topic of the second set of future trending topics 1204 are computed.

Further, the present information on launching of world's cheapest car 1104 is scheduled for Dec. 1^{st} 2012. The future topics computing module 210 of FIG. 2 updates the topic that relate the present information 1104 into the second set of future trending topics 1204. Similarly, based on each present information of the present information 1102 and at least one past occurrence of at least one related trended topic, the first set of future trending topics 1202 and the second set of future trending topics 1204 are predicted.

Likewise, based on present information, future trending topics can be predicted for one or more weeks, one or more months, and/or one or more years. The persistence 1210 associated with a future trending topic of the first set of future trending topics 1202, and the persistence 1216 associated with a future trending topic of the second set of future trending topics 1204 are computed based on a persistence of past trended topic that relates to the future trending topic. For example, past occurrences of trended topics such as “an economical car xyz launched in 2011”, and an “ cheapest car of the year 2010” have a persistence of 1 day. The persistence computing module 214 computes the persistence of a future trending topic associates with a future event ‘launching of world's cheapest car 1104’ that relates to the trended topics (“an economical car xyz launched in 2011” and “ cheapest car of the year 2010”) as 1 day. In one embodiment, the occurrence 1206 of each future trending topic of the first set of future trending topics 1202, and the occurrence of 1212 of each future trending topic of the second set of future trending topics 1204 are obtained by search on the internet.

FIG. 13 is a flow diagram illustrating a method of forecasting an updated set of future trending topics by generating a set of future trending topics and updating the set of future trending topics with a topic that relates to a future event according to an embodiment herein. In step 1302, one or more trended topics associated with past occurrences are obtained. In one embodiment, the one or more trended topics are obtained by processing a first input of user 102 that includes a selection of one or more highly searched topics on the internet over a period of time by the topic collection module 204. In one embodiment, the one or more trended topics are stored in the database 202 with a corresponding time stamp. In step 1304, a first input that includes a selection of first present information currently not trending is processed. In one embodiment, the information collection module 206 of FIG. 2 processes the user 102 input that includes a selection of the first present information that is associated with occurrence of future events. In step 1306, the set of future trending topics and occurrence of the set of future trending topics are computed based on the first present information and at least one past occurrence of at least one trended topic that is associated with the first present information. In step 1308, a second input that includes a selection of second present information that is associated with an occurrence of a future event and one that differs from the first present information is processed. In step 1310, odds of trending of a topic that relates to the future event is computed based on at least one past occurrence of at least one trended topic that is associated with the second present information. In one embodiment, the future topics computing module 210 computes odds of trending of the topic that relates to the future event. In step 1312, the set of future trending topics is updated on an occurrence of the future event that is associated with the topic to obtain the updated set of future trending topics.

FIG. 14 illustrates an exemplary view of the present information 1102 of FIG. 11 with additional present information 1402 that differs from the present information 1102 according to an embodiment herein. The information collection module 206 processes the user 102 input for a selection of the additional present information 1402 from a data portal. In one embodiment, the additional present information 1402 is stored in the database 202 of FIG. 2. For example, the additional present information 1402 includes a data on occurrence of a future event ‘presentation of finance budget 2012’. Further, the future event ‘presentation of finance budget 2012’ have related past occurrences of trended topics such as ‘presentation of finance budget 2011’ and ‘presentation of finance budget 2010’. The weight assigning module 216 assigns a weight for searching a topic that relates to the ‘presentation of finance budget 2012’ based on number of occurrences of related trended topics such as ‘presentation of finance budget 2011’ and ‘presentation of finance budget 2010’. The topic that relates to the additional present information 1402 is updated to the second set of future trending topic 1204 of FIG. 12, since ‘presentation of finance budget 2012’ occurs in the month of December 2012.

FIG. 15 illustrates a table view 1500 of an updated set of future trending topics 1502 obtained by updating the second set of future trending topics 1204 of FIG. 12 with a topic that corresponds to the additional present information 1402 of FIG. 14 according to an embodiment herein. An occurrence 1504, a weight 1506 and persistence 1508 of the topic that corresponds to the additional present information 1402 are computed. The persistence computing module 214 of FIG. 2 computes the persistence 1508 of the topic “finance budget 2012” based on the persistence of related past trended topics (e.g., “finance budget 2011” and “finance budget 2010”). Similarly, the weight computing module 216 computes a weight for the topic “finance budget 2012” based on a number of occurrences of at least one topic that is related to the topic “finance budget 2012” (e.g., “finance budget 2011”, “finance budget 2010”). In one embodiment, the occurrence 1504 of an event associated with the topic “finance budget 2012” is computed by searching of such occurrence in a timely manner over the internet. Description of various embodiments herein provide obtaining one or more trended topics by processing an input that includes selecting highly searched topics in the past, traced over a period of time. However, the user 102 may get the one or more past trended topics from one or more such past trended topic providers.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does fabricate chips or the photolithographic masks used to fabricate chips, the design transmits the resulting design by physical means (e.g., by providing a copy of the storage medium storing the design) or electronically e.g. through the Internet) to such entities, directly or indirectly. The stored design is then converted into the appropriate format (e.g., GDSII) for the fabrication of photolithographic masks, which typically includes creating multiple copies of the chip design in question that are to be formed on a wafer The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either both surface interconnections or buried interconnections). In any case, the chip is then integrated with other chips, discrete circuit elements and/or other signal processing devices as Part of either (a) an intermediate product, such as a motherboard, or (b) an end product. The end product can be any product that includes integrated circuit chips, ranging low-end applications to advanced computer products having a display, a keyboard or other input device, and a central processor. The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from computer-usable or computer-readable medium providing program code for use by or connection with a computer or any instruction execution system. For purposes of this description, a computer-usable or computer readable medium can be any apparatus that can comprise, store, communicate, propagate, or transport the program for use by or in connection with the instruction execution system, apparatus, or device.

The medium can be a electronic, magnetic, optical, electromagnetic, infrared, or semiconductor system (or apparatus or device) or a propagation medium. Examples of a computer-readable medium include a semiconductor of solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters,

FIG. 16 illustrating a representative computer architecture for practicing the embodiments herein. This schematic drawing illustrates a hardware configuration of any information handling/computer system in accordance with the embodiments herein. The system comprises a least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects keyboard 15, mouse 17, speaker 24, microphone 22, and/or other user interface devices such as touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

A set of future trending topics that are predicted by the future topics determining tool 106 of FIG. 1 is more likely to be interesting to, and relevant for, a large number of content consumers, since the prediction is based on already trended topics and present information. Further, the keyword generation module 212 of FIG. 2 provides the content writer(s) 112 a set of related keywords for creating content around each future trending topic from the set of future trending topics. In one embodiment, the set of related keywords are obtained from the database 202. Using the set of related keywords obtained from the trended topics helps (i) creating new content for a new topic, and (ii) potentially increases the number of visits to the site publishing new content pertaining to a new topic that is likely to be a trending topic in the future that would of interest to the content consumers.

The foregoing description of the specific embodiments will also fully reveal the general nature of the embodiments herein that others can, by applying current knowledge, readily modify for and/or adapt to various applications with such specific embodiments without departing from the overall concept. Therefore, such adaptations and modifications should, as are intended to, be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A computer implemented method for computing a set of future trending topics attained by:
(i) obtaining a plurality of trended topics associated with past occurrences;
(ii) processing a first input comprising a selection of present information that is not currently trending, wherein said present information is associated with an occurrence of at least one future event; and
(iii) computing the aforementioned set of future trending topics and occurrences of aforesaid set of future trending topics based on:
(a) said present information; and
(b) at least one past occurrence of at least one trended topic that is associated with said present information.

2. The computer implemented method of claim 1, further comprising:
(iv) providing a plurality of related keywords for each future trending topic of said set of future trending topics; and
(v) generating content on such future trending topics based on at least one of the said plurality of related keywords.

3. The computer implemented method of claim 1, further comprising (vi) computing the number of days a future trending topic of said set of future trending topics is likely to be trending based on the number of days at least one topic that relates to said future trending topic trended in past, wherein at least one such topic is obtained from said plurality of trended topics.

4. The computer implemented method of claim 1, further comprising assigning a weight for each future trending topic that indicates the odds of trending of said each future trending topic based on the number of occurrences of past events relating to said each future trending topic.

5. A system for computing a set of future trending topics comprising:
(i) a memory unit that stores a set of modules;
(i) a display unit that displays said set of future trending topics and occurrences of said set of future trending topics;
(iii) a processor that executes said set of modules, wherein said set of modules comprises:
(a) a topic collection module that is configured to process a first input comprising a selection of a plurality of trended topics associated with past occurrences;
(b) an information collection module that is configured to process a second input comprising a selection of present information that is not currently trending, wherein each present information is associated with an occurrence of at least one future event; and
(c) a computing module for future topics that is configured to compute said set of future trending topics and occurrences of said set of future trending topics based on:
(i) said present information; and
(ii) at least one past occurrence of at least one trended topic that is associated with said present information.

6. The system of claim 5, wherein said set of modules further comprises a keyword generation module that is configured to:
generate a plurality of related keywords for each future trending topic of said set of future trending topics.

7. The system of claim 5, wherein said set of modules further comprises:
a persistence computing module that is configured to compute the number of days a future trending topic of said set of future trending topics is likely to be trending based on the number of days at least one topic that relates to said future trending topic trended in past, wherein said at least one topic is obtained from said plurality of trended topics.

8. The system of claim 5, wherein said set of modules further comprises:
a weight assigning module that is configured to assign a weight for each future trending topic that indicates the odds of trending of said each future trending topic based on the number of occurrences of past events relating to said each future trending topic.

9. A method for generating an updated set of future trending topics comprising:
(i) obtaining a plurality of trended topics associated with past occurrences;
(ii) processing a first input comprising a selection of first present information that is not currently trending, wherein said first present information is associated with an occurrence of at least one event in future; and
(iii) computing said set of future trending topics and occurrences of said set of future trending topics based on:
(a) said first present information; and
(b) at least one past occurrence of at least one trended topic that is associated with said first present information,
(iv) processing a second input comprising a selection of a second present information that differs from said first present information, wherein said second present information is associated with an occurrence of a future event;
(v) computing odds of trending of a topic that relates to said future event based on at least one past occurrence of at least one trended topic that is associated with said second present information; and
(vi) updating said set of future trending topics on an occurrence of said future event associated with said topic to obtain said updated set of future trending topics.

10. The method of claim 9, further comprising (vii) computing the number of days said topic of said future event is likely to be trending based on a number of days at least one trended topic that relates to said topic trended in past.

11. The method of claim 9, further comprising (viii) assigning a weight for said topic indicates the odds of trending of said topic of said future event based on a number of occurrences of past events relating to said topic.
